(19) United States
(12) Patent Application Publication
(10) Pub. No.: US 2017/0123573 A1
(43) Pub. Date: May 4, 2017

(54) ELECTRONIC DEVICE, INFORMATION PROCESSING METHOD, PROGRAM, AND ELECTRONIC DEVICE SYSTEM

(71) Applicant: SONY CORPORATION, Tokyo (JP)

(72) Inventors: Kazuyuki YAMAMOTO, Kanagawa (JP); Akihiro KOMORI, Tokyo (JP); Hiroyuki MIZUNUMA, Tokyo (JP); Ikuo YAMANO, Tokyo (JP); Nariaki SATO, Kanagawa (JP)

(73) Assignee: SONY CORPORATION, Tokyo (JP)

(21) Appl. No.: 15/334,894

(22) Filed: Oct. 26, 2016

Related U.S. Application Data
(63) Continuation of application No. 13/416,569, filed on Mar. 9, 2012.

(30) Foreign Application Priority Data
Mar. 17, 2011 (JP) 2011-058988

(51) Int. Cl. G06F 3/041; G06F 3/042; G06F 3/0481; G06F 3/044

(52) U.S. Cl. CPC G06F 3/0416; G06F 3/044; G06F 3/0421; G06F 3/0481; G06F 2203/04104

(57) ABSTRACT

There is provided an portable electronic device including a touch sensor which acquires operation information input by an operation subject based on an operation performed by an operator on an operation surface, a control section which generates a picture image on which the operation subject is reflected, based on the operation information, and an image generation section which generates an image in which the picture image is superimposed on an original image. According to such a configuration, a user can perform an input with a natural operation while visually recognizing the picture image.

### CROSS-REFERENCE TO PRIOR APPLICATION

This application is a continuation of U.S. patent application Ser. No. 13/416,569 (filed on Mar. 9, 2012), which claims priority to Japanese Patent Application No. 2011-058988 (filed on Mar. 17, 2011), which are all hereby incorporated by reference in their entirety.

### BACKGROUND

The present disclosure relates to an electronic device, an information processing method, a program, and an electronic device system.

In recent years, as a GUI (Graphical User Interface) being in widespread use in a mobile terminal such as a smartphone, there has been introduced an operation input device using a touch sensor, such as a touch panel. The touch panel uses a touch sensor arranged on a liquid crystal display (LCD) screen or the like, and realizes intuitive operation (direct manipulation) by the screen being directly touched. For example, JP 2010-262556A describes a device equipped with two operation modes for an operation to move an object on a capacitive touch panel.

### SUMMARY

A touch panel is extremely useful as an operation input device which enables a user to directly operate on a display screen, but on the other hand, there is a device which has a display screen and a touch sensor (touch pad) separately, as is represented by a notebook computer, for example.

There is an issue in such a device having a display screen and a touch sensor separately that it becomes difficult for the user to recognize the relationship between an operation position (position being in contact with a finger) on the touch sensor and a specified position (position of a cursor, for example) on the screen. As an example, there is given a portable terminal device in which the display screen is provided on the front side and the touch sensor is provided on the back surface (back side of the device). In such a device, since the user operates the back surface of the device, which the user cannot see, with his/her finger, it becomes difficult for the user to recognize the relationship between the operation position on the touch sensor and the specified position on the screen. Further, there may arise a case where a part of the finger touches the touch sensor without being noticed by the user and an unexpected operation may be caused.

Further, as another example of the device hawing the display screen and the touch sensor separately, there is given a controller which operates a user interface (UI) on the screen which is placed away therefrom in a touch panel-manner. Since the user operates the controller in his/her hand while watching the screen in such a device, it becomes difficult for the user to recognize the relationship between the operation position on the touch sensor and the specified position on the screen. Further, there is also assumed a case where a part of the finger touches the touch sensor without being noticed by the user and an unexpected operation is caused. Further, with adoption of a multi-touch input (which makes it possible to display and operate a plurality of cursors in a corresponding manner to a plurality of positions touched by the finger) as an operation input, there arises an issue that it becomes difficult to grasp the absolute positional relationship among a plurality of pointed positions (cursor positions).

In addition, there is another issue that in the case of using the touch pad, even though a cursor is being displayed while the finger is in contact with the touch sensor, the cursor disappears when the finger is released from the touch sensor, and no feedback is given to the screen. Accordingly, the issue is that the user is at a loss where to place the finger next.

In light of the foregoing, it is desirable to provide an electronic device, an information processing method, a program, and an electronic device system which are novel and improved, and which enable the user to perform an input with a natural operation while watching the display screen, without providing the user with an uncomfortable feeling.

According to an embodiment of the present disclosure, there is provided an electronic device which includes an operation information acquisition section which acquires operation information input by an operation subject based on an operation performed by an operator on an operation surface, an image processing section which generates a picture image on which a picture of the operation subject is reflected, based on the operation information, and an image generation section which generates an image in which the picture image is superimposed on an original image.

The electronic device may further include a display section which is provided at a different part from the operation surface, and displays the image in which the picture image is superimposed on the original image.

The operation information may be information received from another device which is provided separately from the electronic device and has the operation surface.

The image processing section may generate information of a position of a representative point of the operation subject based on the operation information. The image generation section may generate an image in which an image at the position of the representative point of the operation subject is superimposed, together with the picture image, on the original image.

The image processing section may generate the picture image as an image obtained by making the original image semitransparent or by trimming the original image.

In a case where a signal strength of the operation information detected by the operation information acquisition section is equal to or less than a predetermined threshold, the image processing section may not generate information of the picture image.

In a case where a signal strength of the operation information acquired by the operation information acquisition section is equal to or less than a first threshold, the image processing section may not generate information of the picture image, and in a case where a signal strength of the operation information detected by the operation information acquisition section is equal to or less than a second threshold, which is larger than the first threshold, the image processing section may not generate the information of the position of the representative point.

The image processing section may perform first low-pass filter processing having a strength to information of the picture image, and may also perform second low-pass filter processing to information of an image of the representative point. The strength of the first low-pass filter processing may be higher than a strength of the second low-pass filter processing.

In a case where a signal strength of the operation information acquired by the operation information acquisition section becomes equal to or less than a predetermined value, the image processing section may estimate and generate the picture image based on a signal strength of the operation information acquired in the past.

In a case where the signal strength of the operation information detected by the operation information acquisition section is equal to or less than a second threshold, which is larger than the first threshold, an input performed by the operation subject may not be accepted.

The image processing section may generate a graphic that is set in advance as information of the picture image, based on the operation information.

The image processing section may generate the picture image corresponding to a distance between the operation surface and the operation subject, based on the operation information.

The image processing section may generate the picture image having a size corresponding to a signal strength of the operation information.

The image processing section may generate the picture image having a density corresponding to a signal strength of the operation information.

In a case where the size of the picture image is equal to or less than a predetermined value, an input performed by the operation subject may not be accepted.

According to another embodiment of the present disclosure, there is provided an information processing method which includes acquiring operation information input by an operation subject based on an operation performed by an operator on an operation surface, generating a picture image on which a picture of the operation subject is reflected, based on the operation information, and generating an imam in which the picture image is superimposed on an original image.

According to another embodiment of the present disclosure, there is provided a program for causing a computer to function as means for acquiring operation information input by an operation subject based on an operation performed by an operator on an operation surface, means for generating a picture image on which a picture of the operation subject is reflected, based on the operation information and means for generating an image in which the picture image is superimposed on an original image.

According to another embodiment of the present disclosure, there is provided an electronic device system including a controller including an operation information acquisition section which acquires operation information input by an operation subject based on an operation performed by an operator on an operation surface, and a transmission section which transmits the operation information, and an electronic device including a reception section which receives the operation information, an image processing section which generates a picture image on which a picture of the operation subject is reflected, based on the operation information, and an image generation section which generates an image in which the picture image is superimposed on an original image.

According to another embodiment of the present disclosure, there is provided an electronic device system including a controller including an operation information acquisition section which acquires operation information input by an operation subject based on an operation performed by an operator on an operation surface, an image processing section which generates a picture image on which a picture of the operation subject is reflected, based on the operation information, and a transmission section which transmits information of the picture image, and an electronic device including a reception section which receives the information of the picture image, and an image generation section which generates an image in which the picture image is superimposed on an original image.

According to the embodiments of the present disclosure described above, it becomes possible for the user to perform an input with a natural operation while watching the display screen, without providing the user with an uncomfortable feeling.

### BRIEF DESCRIPTION OF THE DRAWINGS

FIG. 1 is a schematic view showing an external appearance of a portable electronic device according to a first embodiment;

FIG. 2 is a block diagram showing a configuration of the portable electronic device shown in FIG. 1;

FIG. 3 is a schematic view showing, in a case where a touch sensor is configured from a grid capacitive touch sensor, a grid structure thereof;

FIG. 4 is a schematic view showing, in a case where a touch sensor is configured from an in-cell optical touch sensor, a structure thereof;

FIG. 5 is a feature diagram showing an example of a result obtained by measuring a capacitance scanned by the capacitive touch sensor shown in FIG. 3;

FIG. 6 is a feature diagram showing, at a specific grid among grids shown in FIG. 3, a size of the capacitance in accordance with proximity of or contact with a user's finger;

FIG. 7 is a schematic view showing a capacitance acquired by a touch sensor;

FIG. 8A, FIG. 8B, FIG. 8C, and FIG. 8D are each a schematic view showing a state in which images of cursors are generated based on the capacitance acquired. by the touch sensor like the one shown in FIG. 7 and the images are displayed in a superimposed manner on a screen of a URL received by a transmission/reception section;

FIG. 9 is a schematic view showing an example of a method of determining the center of gravity;

FIG. 10 is a schematic view showing an example of a method of determining a general contour;

FIG. 11 is a block diagram showing low-pass filter processing;

FIG. 12 is a block diagram showing the low-pass filter processing;

FIG. 13 is a schematic view showing an example in which a representative point of a cursor is displayed based on a capacitance and also a picture image 152 is displayed based on the capacitance, and additionally, a shape of actual fingers is displayed;

FIG. 14 is a schematic view showing a display example in which a range and a density of the picture image 152 around the cursor are changed in a process of bringing the finger closer to the touch sensor;

FIG. 15 is a schematic view showing a display example in a case where the finger is moved out of a range in which the capacitance can be detected using the touch sensor;

FIG. 16 is a flowchart showing processing performed in the portable electronic device according to the present embodiment;

FIG. 17 is a configuration diagram showing a configuration of a controller and an electronic device according to a second embodiment;

FIG. 18 is a configuration diagram showing a configuration of a controller and an electronic device according to the second embodiment;

FIG. 19 is a block diagram showing a configuration of the second embodiment;

FIG. 20 is a block diagram showing an example in which the electronic device is a device such as a set-top box and a display section is provided separately;

FIG. 21 is a schematic view showing a state in which the user touches the left-hand side of the touch sensor with his/her left hand thumb and touches the right-hand side of a touch sensor 230 with his/her right hand forefinger;

FIG. 22 is an example of changing a status of the cursor in accordance with the size of capacitance of each grid; and

FIG. 23 is a schematic view showing an example in which information indicating a status (state) of the electronic device is superimposed on a simulated finger image.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Note that the description will be given in the following order.

1. Outline of embodiments

2. First embodiment
2.1. System configuration example
2.2. Configuration example of touch sensor
2.3. Display example on screen
2.4. About low-pass filter processing
2.5. Example of displaying finger shape
2.6. Display example in which range and density of picture image is changed according to distance
2.7. Display example in case where finger is moved out of detectable range of touch sensor
2.8. Processing in portable electronic device of present embodiment

3. Second embodiment (capture control: example of using orientation sensor for detecting pan direction)
3.1. System configuration example
3.2. Display example on screen

### 1. Outline of Embodiments

There is a device which has a display screen and a touch sensor (touch pad) separately, as is represented by a notebook computer. Such a device has a touch pad using a relative coordinate system.

In the touch pad using a relative coordinate system, an operation position (position being in contact with a finger) on the touch pad and a specified position (position of a cursor, for example) on the screen do not correspond to each other on a one-to-one basis. When the user performs an operation to move the cursor on the touch pad, the cursor moves a relative distance corresponding to the operation on the basis of a current cursor position. For example, in the case where the user wants to move the cursor from one end to the other end on the screen, the user moves his/her finger a predetermined distance on the touch pad and repeats the movement of the predetermined distance for several times, and thereby being able to move the cursor from one end to the other end of the screen.

On the other hand, as another coordinate system, there is given an absolute coordinate system, as is represented by a touch panel. In the case of the absolute coordinate system, since a specified position (position being in contact with a finger) on the touch sensor and a specified position (position of a cursor, for example) on the screen correspond to each other on a one-to-one basis, the cursor moves to the left end of the screen when the user touches the left end of the touch sensor, and the cursor moves to the right end of the screen when the user touches the right end of the touch sensor, for example.

In the case where the screen and the touch pad are provided separately, it is general that the relative coordinate system is used, as is represented by the notebook computer. However, the convenience thereof becomes high by using the absolute coordinate system according to scenes. There is given, as an example, a portable terminal device having a touch sensor attached thereto on the back surface of the display device (back side of the device), as will be described in the first embodiment. The device has an operation surface on the back surface, and the display screen on the front side and the operation surface are corresponding to each other on the front and the back, and hence, the device is a so-called simulated touch panel-like operation input device. When the relative coordinate system is used in such a device, the position of the cursor and the position of the finger differ from each other, which confuses the user. Accordingly, the absolute coordinate system is used for such a device, and hence, there can be achieved an operation system with high usability.

The operation system having the touch sensor attached to the back surface of the display device has a great advantage in that the screen is not hidden by the finger, unlike in the case of the touch panel. Accordingly, the display screen is not hidden by the finger and the user can perform the operation equivalent to the operation using the touch panel. On the other hand, since the user operates the back surface of the device, which the user cannot see, with his/her finger, there may arise a case where a part of the finger touches the touch sensor without being noticed by the user and an unexpected operation may be caused. Therefore, it is desirable that the position of the finger be displayed on the display screen of the front side.

Further, there is given, as another example, a controller which operates a user interface (UI) on the screen which is placed away therefrom in a touch panel-manner, as will be described in the second embodiment. Here, with adoption of a multi-touch input (which makes it possible to display and operate a plurality of cursors in a corresponding manner to a plurality of positions touched by the finger) as an operation input, the operation becomes easy if the absolute coordinate system is adopted, because the absolute positional relationship among a plurality of pointed positions (cursor positions) takes an important part. In this case, the user, who is accustomed with the relative coordinates commonly used in the touch pad of an existing notebook PC or the like, may get confused with the difference in coordinate systems.

As described above, it is general that GUI system (Windows (registered trademark) PC or the like) of the past using a pointing device uses the relative coordinate system as the coordinate system for the operation. However, in the case of attempting to realize a direct manipulation-like operation feeling using the touch pad, it is desirable that the absolute coordinate system be used, because it is necessary to directly operate the position of the operation object. In addition, also in the case of performing a multi-touch operation, it is desirable that the absolute coordinate system be used in order not to disrupt the positional relationship among fingers.

Further, in the case of using the touch pad, even though a cursor is being displayed while the finger is in contact with the touch sensor, the cursor disappears when the finger is released from the touch sensor, and no feedback is given to the screen. Accordingly, there may arise an issue that the user is at a loss where to place the finger next.

Therefore, in each embodiment to be described hereinafter, picture information of a finger acquired by each grid of the touch sensor is visualized and displayed on the screen. Here, in the case of displaying the picture information of the finger, a predetermined threshold can be used such that display is performed even when it is in a non-contact, proximity state. Further, a cursor for the pointing can be superimposed on the picture information. Still further, in the case where the finger is not in contact with the touch sensor and is only in proximity thereto, the cursor can be made not to be superimposed or not to function. According to such a configuration, there can be performed visual feedback of the place of the user's finger (prior to the contact), and it is possible to enhance the operability of the touch pad using absolute coordinates. Hereinafter, each embodiment will be described in detail.

### 2. First Embodiment

### 2.1. System Configuration Example

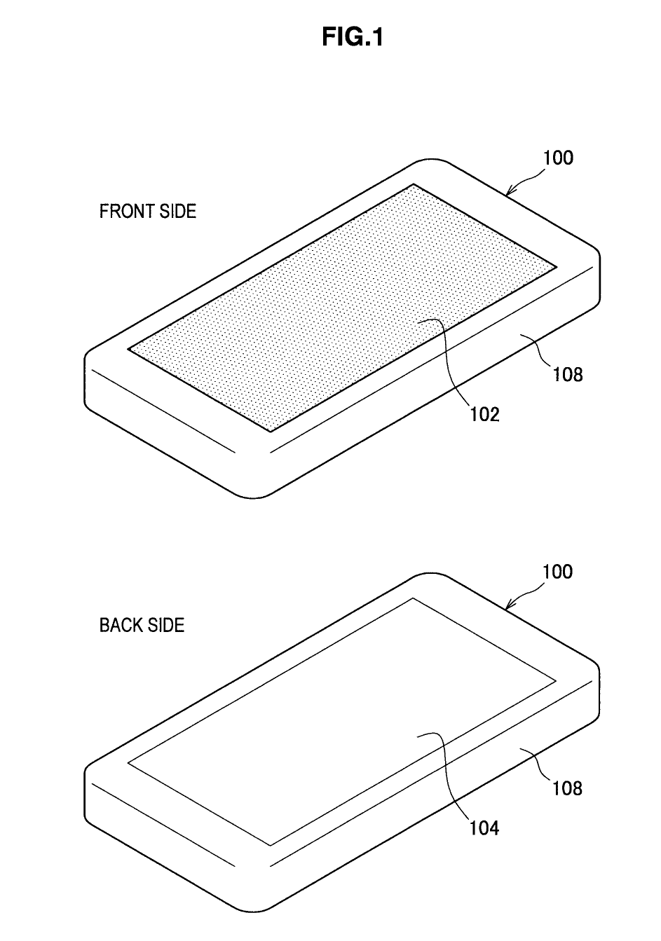

The present embodiment relates to a controller of a GUI (Graphical User interface), and a portable electronic device using a touch sensor will be given as an example and described. FIG. 1 is a schematic view showing an external appearance of a portable electronic device 100 according to a first embodiment. The portable electronic device 100 includes a display section 102 provided on the front surface of a casing 108 and a touch sensor 104 arranged on the back side surface thereof. The display section 102 is configured from a liquid crystal display (LCD) panel or the like, for example. Further, the touch sensor 104 can be configured from a capacitive touch sensor as an example, but is not limited thereto. The user holds the portable electronic device 100 with the display section 102 facing upward and operates the touch sensor 104 on the back surface, and thus, the user can move a cursor displayed on the display section 102, can select an icon, and can perform an operation such as a drag operation.

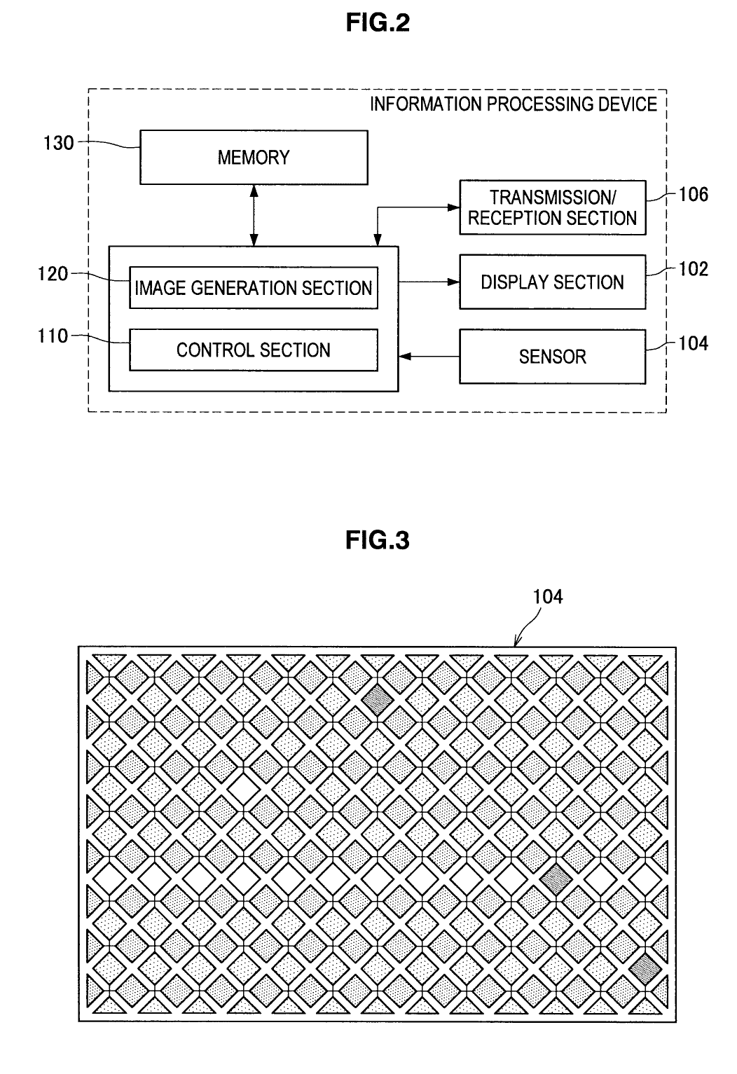

FIG. 2 is a block diagram showing a configuration of the portable electronic device 100 shown in FIG. 1. As shown in FIG. 2, the portable electronic device 100 includes the display section 102, the touch sensor 104, a transmission/reception section 106, a control section 110, an image generation section 120, and a memory 130.

The transmission/reception section 106 transmits/receives information via a wireless communication network. The touch sensor 104 detects proximity of or contact with the user's finger. The touch sensor 104 transmits detection results to the control section 110. The control section 110 generates information to be displayed on the display section 102 based on the detection results transmitted from the touch sensor 104, and transmits the information to the image generation section 120. Here, the information generated by the control section 110 includes an image of a representative point 150 of the cursor and a picture image 152, which will be described below. The control section 110 functions as an operation information acquisition section for acquiring the results detected by the touch sensor 104, and as an image processing section for generating the representative point 150 and the picture image 152. Further, the control section 110 performs overall processing of the portable electronic device 100, such as content selection and drag operation, based on the operation of the cursor. The image generation section 120 superimposes the information transmitted from the control section 110 on an image received by the transmission/reception section 106 or an image stored in the memory 130, and thereby generating data of an image to be displayed on the display section 102. The image data generated by the image generation section 120 is transmitted to the display section 102 and is displayed on the display section 102. The memory 130 stores information related to proximity or detection of the users finger and information of an image and the like.

The configuration shown in FIG. 2 can include hardware (circuit) or a central processing unit (CPU) and software (program) for causing it to function. In this case, the program can be stored in a storage section included in the portable electronic device 100, such as the memory 130, or in a recording medium inserted from outside.

### 2.2. Configuration Example of Touch Sensor

FIG. 3 is a schematic view showing, in a case where the touch sensor 104 is configured from a grid capacitive touch sensor, a grid structure thereof. As shown in FIG. 3, the touch sensor 104 has a capacitance sensor arranged in a grid (lattice)-like manner, and is configured in a manner that the capacitance of the user's finger that comes close to or in contact with the front surface is sequentially scanned for each grid.

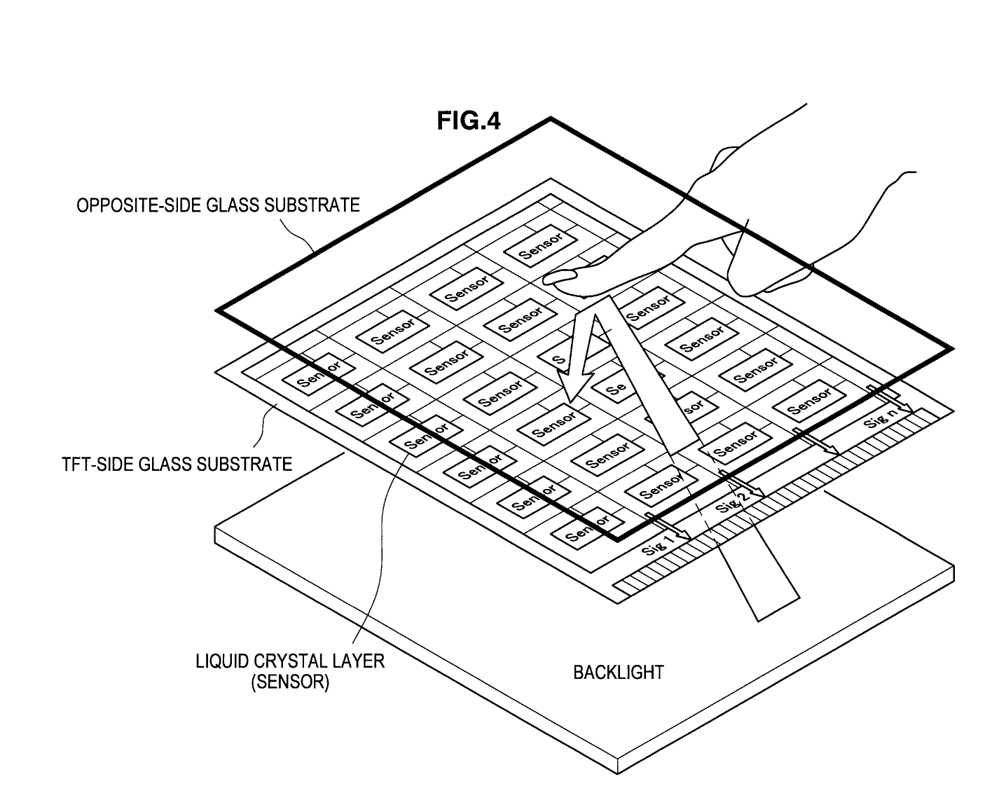

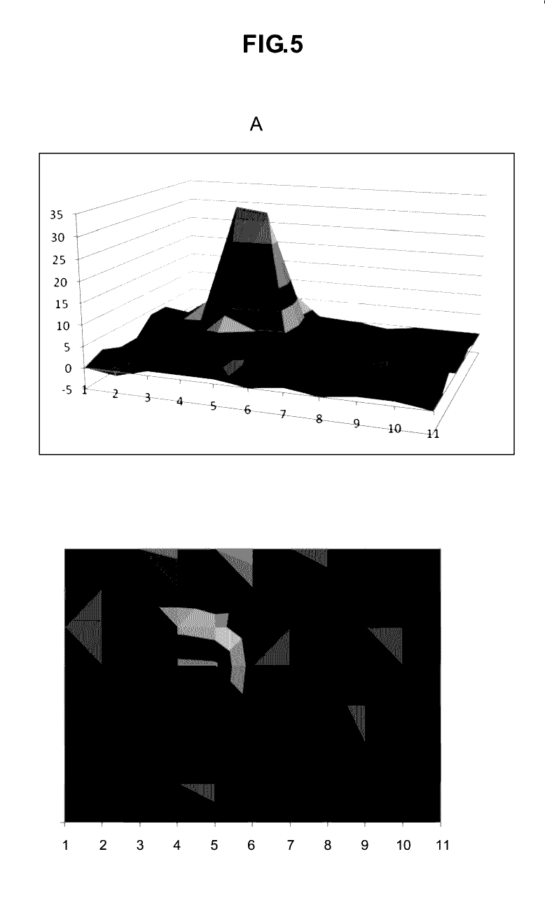

Further, FIG. 4 is a schematic view showing, in a case where the touch sensor 104 is configured from an in-cell optical touch sensor, a structure thereof. The in-cell optical touch sensor includes a backlight, a TFT-side glass substrate, a liquid crystal layer (sensor), and an opposite-side glass substrate. In the case of using an optical touch sensor, as shown in FIG. 4, light is projected from the backlight, the strength of the reflected light is detected by the liquid crystal layer (sensor), and the proximity of or contact of the user's finger with the front surface of the touch sensor is detected.

FIG. 5 is a feature diagram showing an example of a result obtained by measuring a capacitance scanned by the capacitive touch sensor 104 shown in FIG. 3. In FIG. 5, in order to show it in an easy-to-understand way, the polarity of the capacitance value obtained by the touch sensor 104 is reversed. Accordingly, hereinafter, the description will be made on the basis that as the user's finger comes closer to the touch sensor 104, the capacitance value (value obtained by reversing the polarity) becomes smaller. As shown in FIG. 5, the capacitance is locally small in the area shown with an arrow A, and it can be detected that the user's finger comes close to or in contact with the surface in this area.

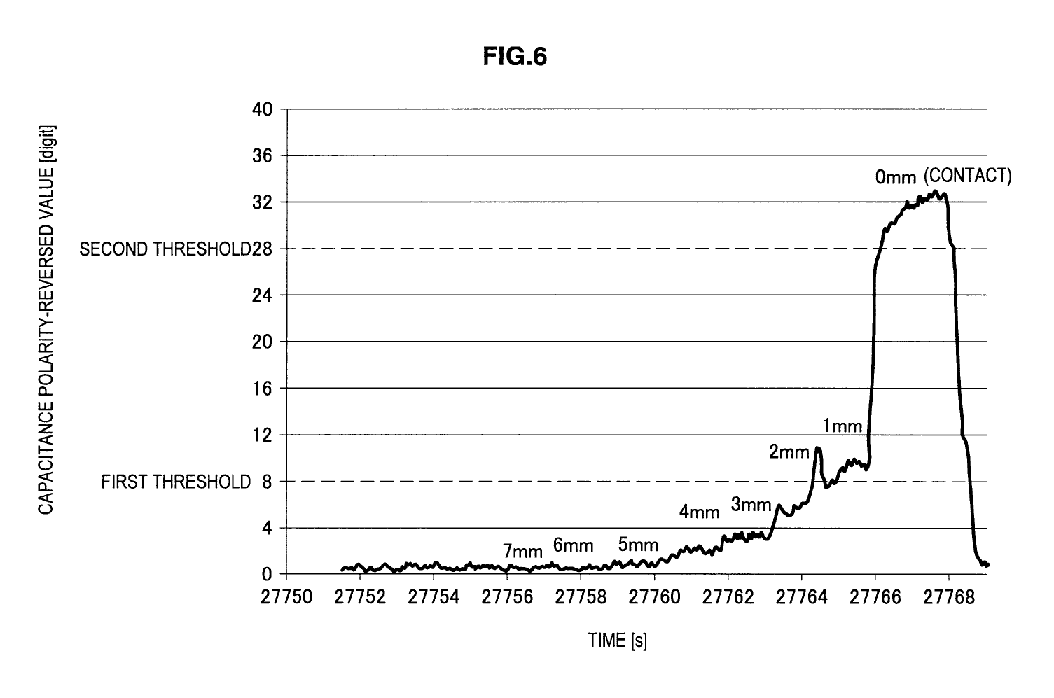

FIG. 6 is a feature diagram showing, at a specific grid among grids shown in FIG. 3, a size of the capacitance in accordance with proximity of or contact with a user's finger. Here, the vertical axis represents the size of the capacitance, and the horizontal axis represents elapsed time in the process of bringing the finger close to the front surface of the touch sensor 104. Further, the numerical values shown in FIG. 6 each represent a distance (mm) from the user's finger to the front surface of the touch sensor 104. As shown in FIG. 6, the capacitance detected by the touch sensor 104 decreases as the user's finger comes closer to the front surface of the touch sensor 104, and becomes the minimum when the finger touches the front surface.

### 2.3. Display Example on Screen

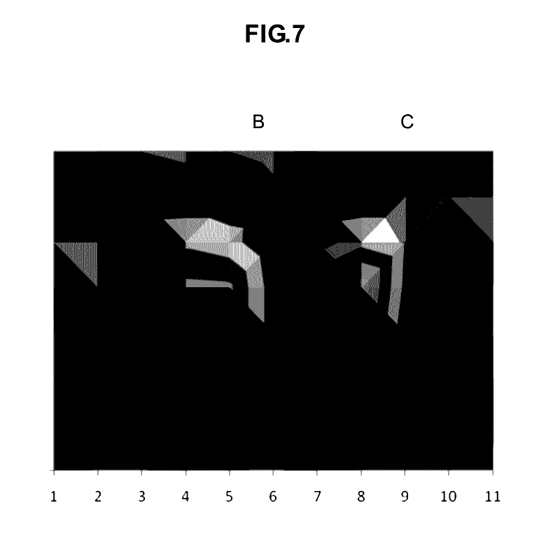

Next, display of an image on the display section 102 will be described. On the display section 102, the image received by the transmission/reception section 106 and the information generated based on the detection results transmitted from the touch sensor 104 are displayed in a superimposed manner. FIG. 7 is a schematic view showing a capacitance acquired by the touch sensor 104 with a contour. Here, there is shown a result obtained in the case where the left hand thumb and the right hand thumb touch the touch sensor 104 at the same time, and a state is shown in which the capacitance values are lower at an area B and an area C, the left part and the right part of the touch sensor 104, compared to the surroundings.

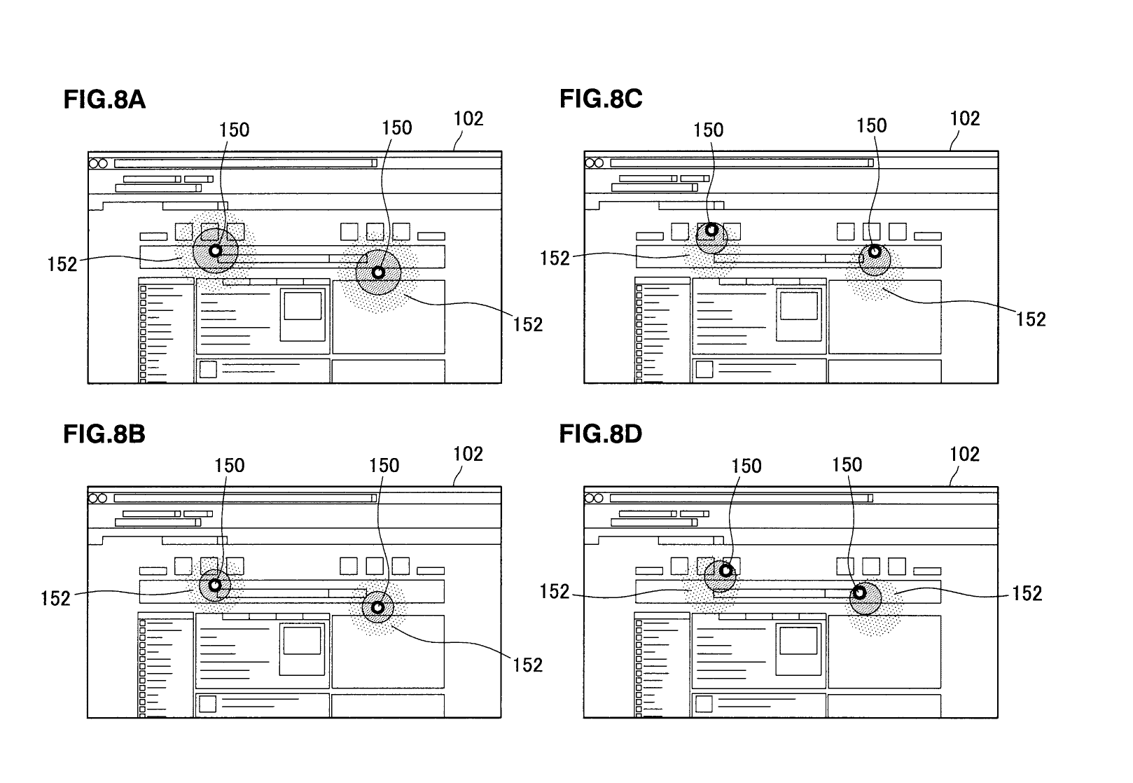

Further, FIGS. 8A to 8D are each a schematic view showing a state in which images of cursors are generated based on the capacitance value shown in FIG. 7 and the images are displayed in a superimposed manner on a screen of a URL received by the transmission/reception section 106. Here, there is shown an example in which images of cursors are superimposed on a screen of a search engine URL received by the transmission/reception section 106. FIGS. 8A to 8D each show an example in which a capacitance value of each grid of the touch sensor 104 shown in FIG. 7 is shown in a graphic form and is superimposed on the screen. Accordingly, in each of FIGS. 8A to 8D, the cursors corresponding to two parts, the right hand thumb and the left hand thumb, respectively, are displayed.

FIG. 8A represents an example in which a contour having a size of the capacitance is determined, and the counter is expressed by the picture image 152 (image on which a picture of the finger is reflected) and is superimposed on the screen. Here, the white circle part at the central part shows the representative point (the center of the cursor) 150 of the cursor that moves in accordance with an operation. The representative point 150 is a reference point in the case of performing an operation of selecting content, a drag operation, and the like. The representative point 150 is determined as the center of gravity to which a capacitance value of each grid exceeding a threshold is added, for example. Further, a picture image 152 part is displayed in a shape corresponding to the capacitance value, at or around the part at which the finger is in contact with the touch sensor 104. Accordingly, the picture image 152 part corresponds to the shape of the finger. In the picture image 152 part, the contour corresponding to the capacitance value is displayed. Further, dots are displayed in accordance with the capacitance value, and the density of the dots to be displayed becomes higher as the finger is closer to the touch sensor 104. Further, the control section 110 may perform semitransparency or trimming processing (frame is rendered, and inside thereof is transparent or semitransparent) to the picture image 152 part, in order not to hide the GUI and the content, which are original images. Further, in FIG. 8A, the colors of the representative point 150 and the surrounding picture image 152 to be superimposed on the image may be changed in accordance with the left hand finger and the right hand finger, for example.

In this way, the picture image 152 part shown in FIG. 8A shows the finger being in contact with the touch sensor 104 in a simulated manner. When the user touches the touch sensor 104 on the back side surface of the portable electronic device 100, the user can visually recognize which position the finger at the hack side surface indicates on the screen displayed on the display section 102, by visually confirming the representative point 150 and the surrounding picture image 152 which are displayed on the display section 102 on the front surface.

In the display of FIG. 8A, the control section 110 determines the center of gravity based on the capacitance value of FIG. 7 and generates the position of the representative point 150. Further, the control section 110 determines the contour based on the capacitance value of FIG. 7, and generates information of picture image 152 corresponding thereto. The image generation section 120 uses the information generated by the control section 110, and superimposes the representative point 150 and the picture image 152 on a URL image received by the transmission/reception section 106, and thereby generating the image to be displayed.

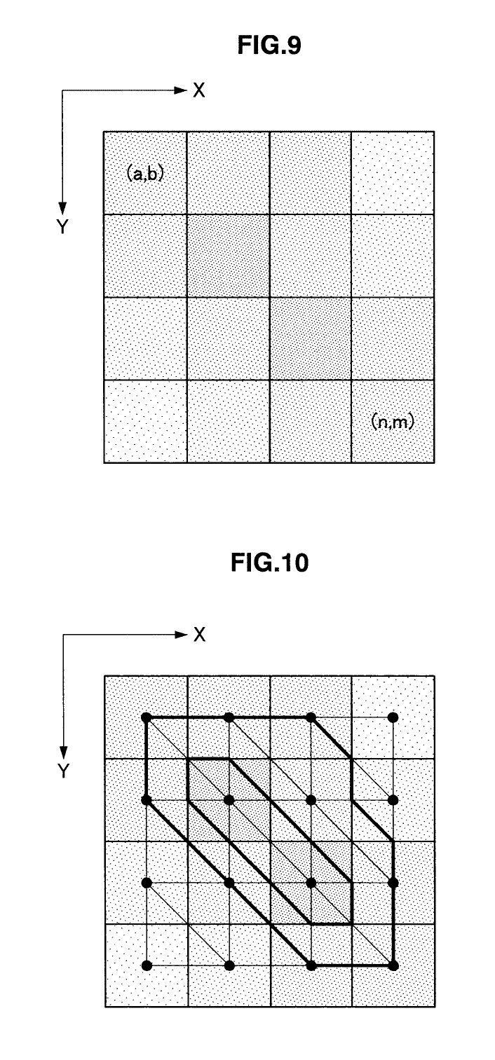

The position of the representative point 150 may be represented by the position of the center of gravity having the minimum capacitance size. FIG. 9 is a schematic view showing an example of a method of determining the center of gravity. FIG. 9 schematically shows the size of the capacitance of each grid (16 grids are shown in FIG. 9) using shading, and a grid having a larger degree of shading has smaller detected capacitance. Here, where the coordinates of the center of gravity is represented by (Xcg, Ycg), the position of the center of gravity can be determined from the following Equations.

$$\text{?}$$

$$\text{?} \text{indicates text missing or illegible when filed}$$

In the Equation above, Z(i,j) represents the size of capacitance at coordinates (x,y)=(i,j).

FIG. 10 is a schematic view showing an example of a method of determining a general contour. The contour can be determined in accordance with the following processes.

(Process 1) As shown in FIG. 10, set triangles each formed by connecting centers of grids.

(Process 2) Compare the sizes of capacitance values of three vertices of each triangle with each other, sort the vertices by size, and name the vertices T1, T2, and T3, respectively, in ascending order of capacitance value, for example.

(Process 3) Determine one end of a contour in one of the triangles. In this triangle, the end of the contour passes through a side T1-T3 connecting the vertices T1 and T3. For example, when the value d of the contour satisfies T1<T3, the end of the contour passes through the point obtained by prorating the value d with the capacitance values of the vertices T1 and T3 on the side T1-T3.

(Process 4) Determine the other end of the contour in this triangle. When the value d of the contour satisfies T1<d<T2, the other end of the contour passes through a side T1-T2 connecting the vertices T1 and T2. Further, when the value d of the contour satisfies T2<d<T3, the other end of the contour passes through a side T2-T3 connecting the vertices T2 and T3. Still further, when the value d of the contour satisfies d=T2, the other end of the contour passes through the vertex T2, Still further, when the value d of the contour satisfies d=T3, the other end of the contour passes through the vertex T3.

In this way, the above processes 1 to 4 are performed for each triangle, and thus, the contour passing through each triangle can be uniquely determined. Further, by interpolating the thus determined contour (polygon) using a spline curve, a curved. contour can be obtained.

Further, it is not necessary that the image of the representative point 150 and the surrounding picture image 152 be output in a shape or a size on which the capacitance value is directly reflected, and the image may be deformed as shown in FIG. 8B, FIG. 8C, and FIG. 8D, for example.

FIG. 8B shows an example of an image of the picture image 152 corresponding to the contour having the representative point 150 as its center, which is reduced compared to that of FIG. 8A. With such processing, since the area of the picture image 152 becomes smaller, it can be prevented that a busy state occurs in the screen caused by the picture image 152 (finger image) displayed on the screen. Further, in order to prevent the busy state in the screen, it is also possible to realize it by increasing the degree of transparency of the picture image 152 part.

FIG. 8C shows an example in which the representative point 150 is shifted in a predetermined direction in a step-by-step manner, with respect to the picture image 152 using the contour. Here, processing is added such that as the capacitance decreases, the representative point 150 is shifted to the upper side of the screen with respect to the picture image 152. The reason for performing such processing is that, even though the user intends to touch the front surface of the touch sensor 104 with the tip end of the finger (positioned at an upper side of the screen, in many cases), actual capacitance-acquisition data becomes the minimum at approximately the center of the finger (bulb of the finger), and the difference between the user's consciousness and the actual position of the representative point 150 may provide the user with an uncomfortable feeling. By shifting the position of the representative point 150 as shown in FIG. 8C, the uncomfortable feeling can be suppressed.

FIG. 8D shows an example in which, in the display of FIG. 8C, the representative point 150 is further shifted in the left and right directions. Note that, in FIG. 8D, the shift in the upper direction described in FIG. 8C and the shift in the left and right directions are mixed, but the processing of FIG. 8D may be only the shift in the left and right directions.

In the example of FIG. 8D, processing is added such that, with respect to the right cursor, as the capacitance decreases, the representative point 150 shifts more to the left compared to the actual capacitance peak position. Further, processing is added such that, with respect to the left cursor, as the capacitance decreases, the representative point 150 shifts more to the right compared to the actual capacitance peak position. Those are because, in the same manner as in FIG. 8C, the user who touches the front surface of the touch sensor 104 with his/her right hand recognizes the position of the cursor to be at the upper left of the actual peak position, and the user who touches the front surface of the touch sensor 104 with his/her left hand recognizes the position of the cursor to be at the upper right of the actual peak position.

Further, in the case where two fingers, a left hand finger and a right hand finger, come close to each other that they nearly touch each other, there is assumed a case where, if the actual capacitance peak position is set to the position of the representative point 150, there is a gap between the two cursors and it is difficult for the cursors to reach an icon and the like placed between the cursors. However, by adding the processing shown in FIG. 8D, the case can be avoided in which it is difficult for the cursors to reach an icon and the like, because the distance between the two representative points 150 can be set to substantially 0 when two fingers come closer to (not necessarily touch) each other.

In FIG. 8D, the following method is exemplified as a method of shifting the representative point 150 either in the left direction or the right direction. First, in the case where the coordinates of the representative point 150 corresponding to the finger that conies into contact first is on the right-hand side with respect to the left/right center line of the touch sensor 104, it is determined that the touched finger is a right hand finger, and the representative point 150 is shifted to the left with respect to the actual capacitance peak position. Further, in the case where the coordinates of the representative point 150 corresponding to the finger that comes into contact first is on the left-hand side with respect to the left/right center line of the touch sensor 104, it is determined that the touched finger is a left hand finger, and the representative point 150 is shifted to the right with respect to the actual capacitance peak position.

In the case where fingers are in contact with the touch sensor 104 at two parts and there are two representative points 150, it is determined that the right representative point 150 corresponds to the right hand and the left representative point 150 corresponds to the left hand, and the right representative point 150 is shifted to the left with respect to the actual capacitance peak position, and the left representative point 150 is shifted to the right with respect to the actual capacitance peak position.

Note that, after the shift direction is determined, the shift direction may be determined, not being dependent on the method described above but being dependent on a tracking of the cursor. Further, in the case where there is only one cursor, it may be set such that the cursor is not shifted to the left or right.

The representative point 150 and the picture image 152 shown in FIG. 8 are displayed using the absolute coordinate system. In this case, since the picture image 152 shows the finger image, the user can intuitively recognize from the display of the picture image 152 that it is the absolute coordinate system. In the case where the touch sensor 104 and the display section 102 are provided separately, although it becomes difficult to grasp the relative positional relationship of fingers, the display of the picture image 152 showing the finger in a simulated manner can facilitate the user's understanding. In this way, even in the multi-touch case, the user can operate each cursor without getting confused.

Further, in the case where the touch sensor 104 is provided on the back surface, although there is assumed a case where the finger touches the operation surface unintentionally, the display of the picture image 152 showing the finger in a simulated manner makes it easier to recognize which position on the screen corresponds to the finger, and thus, an erroneous operation can be prevented. Note that the display is not limited to the absolute coordinate system, and may also be the relative coordinate system.

### 2.4. About Low-Pass Filter Processing

Further, in FIG. 8, the cursor (representative point 150) is further superimposed on the simulated finger image in which the contour is represented by the picture image 152, and there are some cases where the capacitance sensor has relatively large noise, and some cases where an edge shape such as an outline stands out. In order to prevent such a situation, low-pass filter (LPF) processing can be performed to the capacitance value of each grid that is a base of the contour to be rendered.

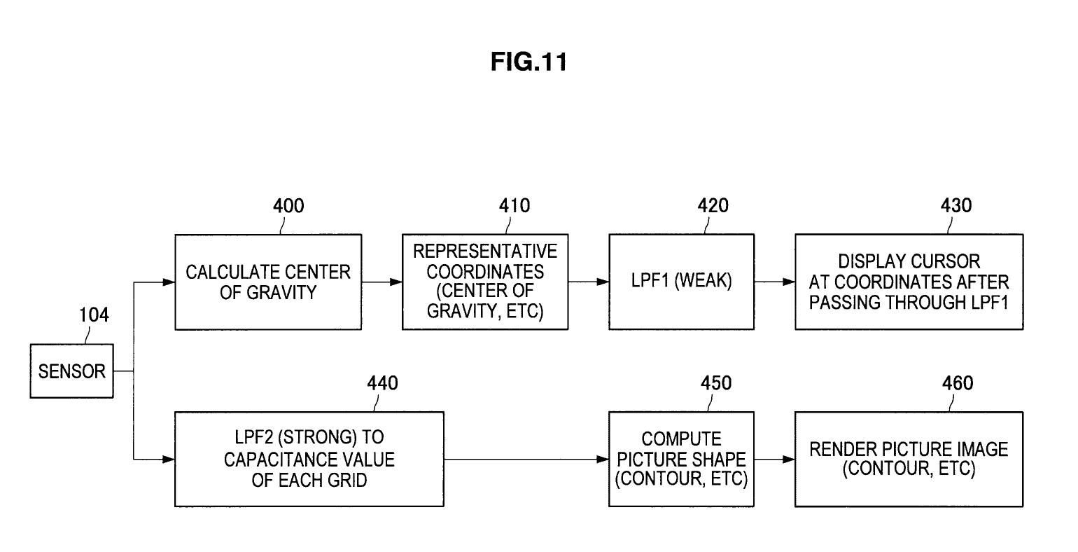

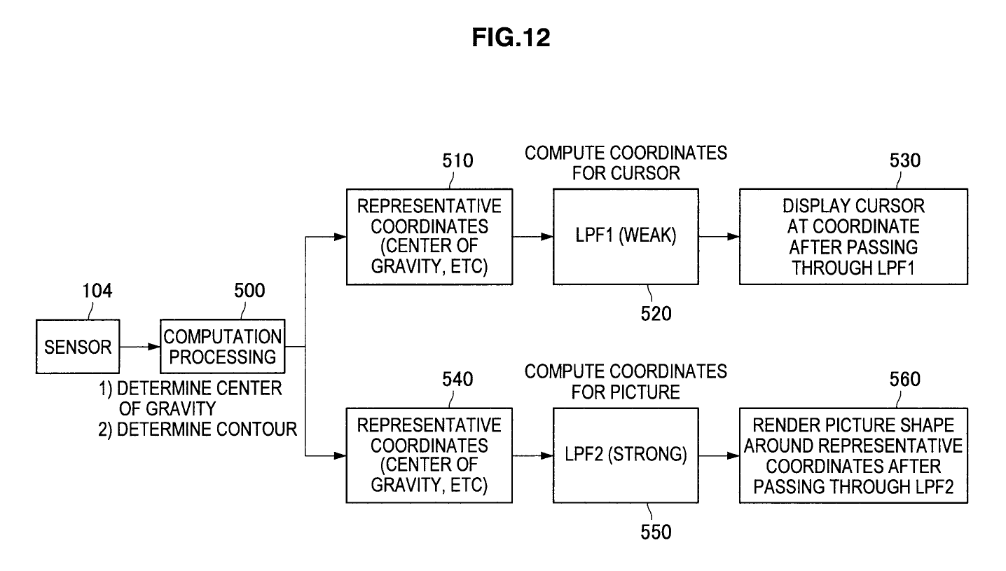

FIG. 11 and FIG. 12 are each a block diagram showing low-pass filter processing. The low-pass filter processing is performed in the control section 110. In the processing shown in FIG. 11, when determining coordinates of the representative point 150 of the cursor, the center of gravity is calculated without performing the low-pass filter processing to the capacitance value of each grid (Blocks 400, 410), weak low-pass filter (hereinafter, referred to as LPF1) processing is performed to the coordinates of the center of gravity (Block 420), and the coordinates after passing through LPF1 is displayed as the representative point 150 (Block 430). On the other hand, in the case of determining the picture image 152 represented by the contour, strong low-pass filter (hereinafter, referred to as LPF2) processing is performed to the capacitance value of each grid (Block 440), the picture image 152 is computed from the capacitance value after LPF2 processing (Block 450), and the picture image 152 is displayed (Block 460).

Further, in the processing shown in FIG. 12, after the center of gravity and the picture image 152 are computed from the capacitance value of each grid (Block 500), weak low-pass filter (LPF1) processing is performed to representative coordinates of the center of gravity (Block 520), and strong low-pass filter (LPF2) processing is performed to the picture image 152 (Block 550). Then, the center of gravity (representative point 150) after LPF1 processing is displayed (Block 530), and the picture image 152 after LPF2 processing is rendered around the coordinates of the representative point 150 (Block 560). Note that, in FIG, 11 and FIG. 12, it is also possible to omit LPF1 processing.

According to such processing, although some latency occurs for the movement of the simulated finger image represented by the picture image 152 compared to the movement of the representative point 150, the edge of the image of the picture image 152 can be restrained from becoming rough, and the edge can be prevented from becoming wobbly. Further, by determining the image of the picture image 152 with a low-pass filter other than the coordinate computation of the representative point 150, the latency related to the movement of the representative point 150 is not deteriorated, and hence, satisfactory operability can be maintained. In addition, since the operation-following capability of the coordinate cursor is higher than that of the simulated finger picture represented by the picture image 152, the operability can be made satisfactory. Further, by performing slightly stronger LPF2 to the simulated finger picture represented by the picture image 152, the movement thereof is stabilized, and the busy state in the screen can be reduced.

### 2.5. Example of Displaying Finger Shape

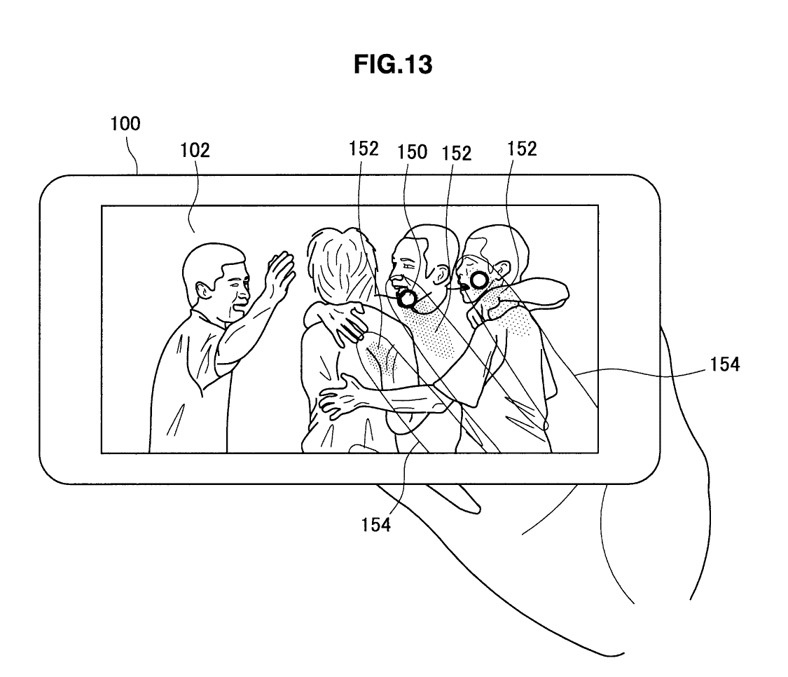

FIG. 8 displays the representative point 150 and the picture image 152 in accordance with the position of the finger, and an actual finger shape can also be displayed together with the representative point 150. FIG. 13 is a schematic view showing an example in which the representative point 150 of the cursor is displayed based on a capacitance and also, the picture image 152 is displayed based on the capacitance, and additionally, a shape 154 of an actual finger is displayed. As described above, since the capacitance is detected for each grid in accordance with the degree of proximity with the touch sensor 104, in the case where a finger comes closer to the touch sensor 104, the capacitance is detected in accordance with the shape thereof. Therefore, as shown in FIG. 13, an image of finger shape can be generated in accordance with the capacitance, and the image can be superimposed. According to such a display, the user can reliably recognize visually the position of the finger operating the back surface of the portable electronic device 100, and can perform a desired operation.

Also in the example shown in FIG. 13, an actual capacitance peak value is detected at a position of a bulb of each finger, and the representative point 150 is shifted in the upper direction from the peak position and is displayed. Further, in the example shown in FIG. 13, since the right hand forefinger and middle finger are in contact with the touch sensor 104, the representative points 150 are displayed. On the other hand, although the ring finger comes closer to the touch sensor 104, it is not in contact therewith. Accordingly; the shape 154 of the ring finger and the picture image 152 corresponding to the ring finger are displayed on the display section 102, but the representative point 150 corresponding to the ring finger is not displayed. In this way, also in the case where the finger is not in contact with the touch sensor 104, the representative point 150 is not displayed and the shape 154 of the finger and the picture image 152 are displayed, and thereby enabling the user to recognize positions of respective fingers on the touch sensor 104 on the back surface from the display on the display section 102.

### 2.6. Display Example in which Range and Density of Picture Image is Changed According to Distance

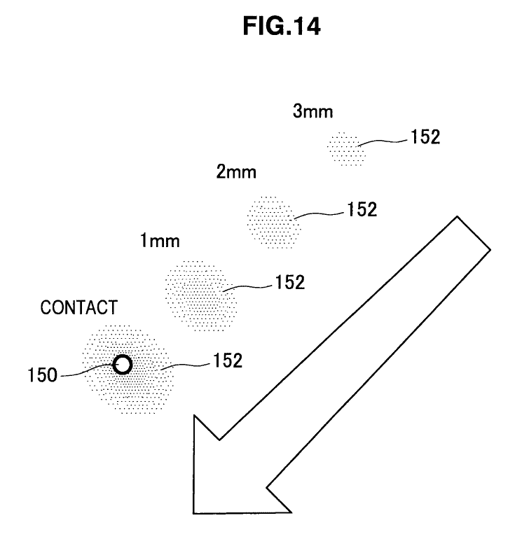

FIG. 14 is a schematic view showing a state in which a range and a density of the picture image 152 around the cursor are changed in a process of bringing a finger closer to the touch sensor 104. In FIG. 14, distances of 3 mm 2 mm, and 1 mm each represent a distance between the touch sensor 104 and the finger. As shown in FIG. 14, as the finger is brought closer to the touch sensor 104, the area of the picture image 152 increases. Further, as the finger is brought closer to the touch sensor 104, the density of the dots of the picture image 152 increases in accordance with a contour. Then, when the finger touches the touch sensor 104, the area of the picture image 152 becomes the maximum, and at the same time, the representative point 150, which is the center of the cursor, is displayed and it becomes possible to perform operations using the representative point 150, such as icon selection, scrolling, and dragging. According to such a display, the user can visually recognize the distance between the touch sensor 104 and the finger, and can also visually recognize whether it is actually possible to perform operation input such as icon selection.

Description will be made based on FIG. 6. In the case where the capacitance value is equal to or more than a first threshold, the picture image 152 is not displayed. Further, in the case where the capacitance value is equal to or more than a second threshold, the representative point 150 is not displayed. Accordingly, in the case where the capacitance value is smaller than the first threshold and equal to or more than the second threshold, only the picture image 152 is displayed. Further, in the case where the capacitance value is smaller than the second threshold, the finger is in contact with the touch sensor 104 or the distance between the finger and the touch sensor 104 is extremely small, and therefore, the representative point 150 and the picture image 152 are both displayed. Further, in the case where the capacitance value is equal to or more than the first threshold, neither the representative point 150 nor the picture image 152 is displayed.

In this way, while the finger is not in contact with the touch sensor 104 and is in the proximity state, since the simulated finger picture (picture image 152) is displayed and the cursor (representative point 150) is not displayed, the user is notified of the finger position and also notified that operations cannot be performed. In this way, while there is only rendered the picture image 152 of the finger, the configuration can be such that free cursor operations such as selection, determination, and dragging cannot be performed. Further, in the case where the size of the picture image 152 is equal to or less than a predetermined value, the configuration can be such that the free cursor operation cannot be performed, and thus, operation can be prohibited when the size of the finger is small, which can realize processing such as a child lock.

In FIG. 14, the picture image 152 can be exactly rendered based on the capacitance value. Further, without being exactly rendered based on the capacitance value, the picture image 152 can be rendered using image templates (circle, square, and the like) with different sizes prepared in advance, which are defined based on the size of the capacitance. In this case, as the capacitance decreases and the finger comes closer to the touch sensor 104, an image template with larger area size is used. Here, the angle of the finger and an aspect ratio of a shape such as an oval may be generated based on a contour. By performing such processing, even when the user releases his/her finger from the touch sensor 104, a simulated finger image in accordance with the distance can be rendered as long as the finger is within the range in which the capacitance of the finger can be acquired, and therefore, it can be prevented that the cursor suddenly disappears and the user gets confused.

### 2.7. Display Example in Case where Finger is Moved out of Detectable Range of Touch Sensor

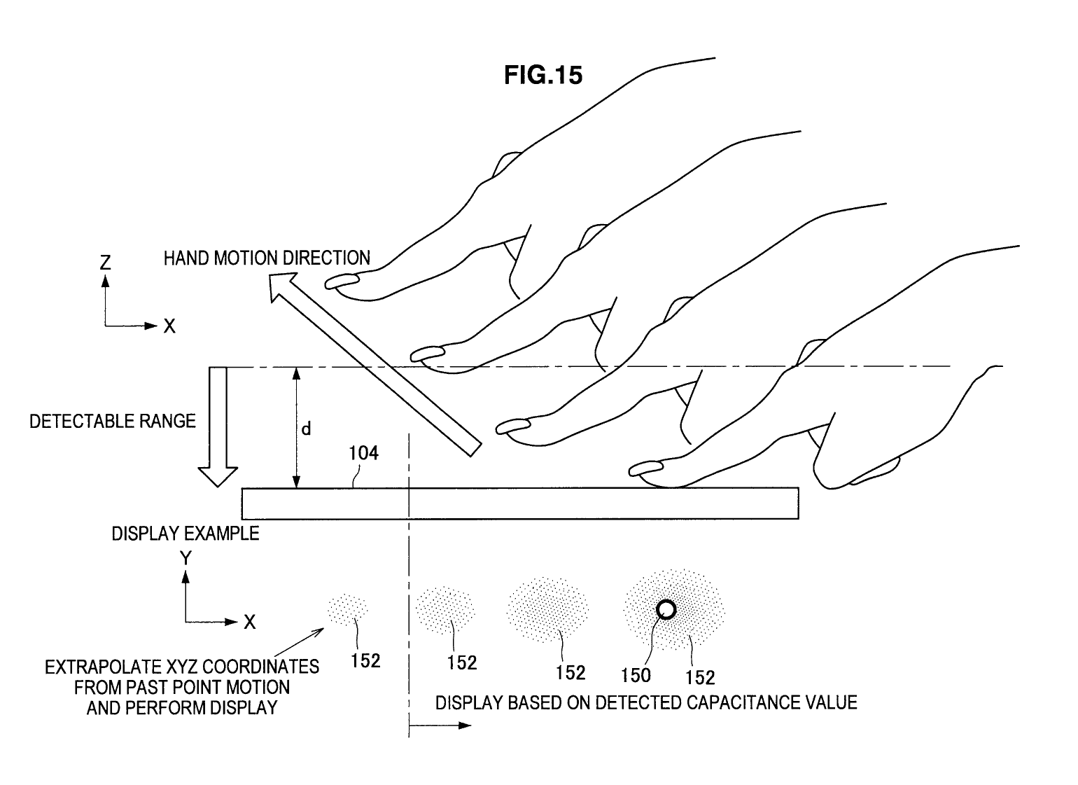

FIG. 15 is a schematic view showing a display example in a case where the finger is moved out of a range in which the capacitance can be detected using the touch sensor 104. In the case where the range in which the capacitance can be detected using the touch sensor 104 is in a range of a distance d from the front surface of the touch sensor 104, the display is performed such that, within the detectable range, the range of the picture image 152 becomes smaller as the finger is farther away from the front surface of the touch sensor 104, as described in FIG. 14. In the case where the finger is moved out of the detectable range, the position of the finger is estimated based on the motion of the hand of the past, and the picture image 152 is displayed at the estimated position. The control section 110 detects the xyz coordinates of the finger motion based on the capacitance when the finger is in the detectable range, estimates the xyz coordinates of the finger based on the xyz coordinates of the finger acquired in the past within the detectable range when the finger is moved out of the detectable range, and displays the picture image 152 at the estimated xy position in a range corresponding to the estimated z position. Here, x coordinates lie at right angles to y coordinates on the front surface of the touch sensor 104, and z coordinates represent coordinates in a direction that goes away perpendicularly from the front surface of the touch sensor 104.

The range in which a finger can be detected in a proximity distance is about 4 mm from the front surface of the touch sensor in the case of a self-capacitance capacitive sensor, about 20 mm from the front surface of the touch sensor in the case of a mutual capacitive sensor, and about 30 mm from the front surface in the case of an in-cell optical touch sensor. Accordingly, there may be a case where the finger performing operation cannot be detected depending on situations. In such a case, as shown in FIG. 15, the disappearance of the picture image 152 on the screen can be reduced by estimating the position at which the finger should be and rendering the picture image 152, based on the trace before the disappearance of the picture image 152 corresponding to the finger. Example of the estimation method includes a technique involving calculating an average of movement speeds of past n histories, and adding the average to the latest coordinates. As described above, by extrapolating the simulated finger motion represented by the picture image 152, the direction in which the finger moves can be shown to the user.

### 2.8. Processing in Portable Electronic Device of Present Embodiment

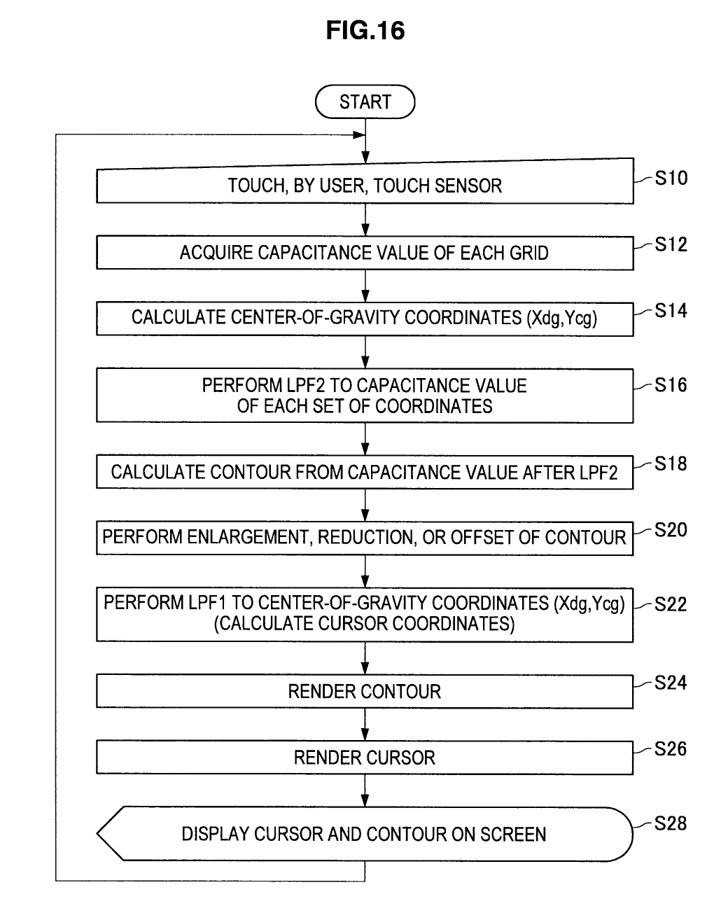

Next, based on FIG. 16, the processing performed by the portable electronic device 100 according to the present embodiment will be described. First, in Step S10, a user touches the touch sensor 104. In Step S12 which follows, the touch sensor 104 acquires a capacitance value of each grid, and transmits the capacitance to the control section 110. Next, in Step S14, based on the capacitance value of each grid, coordinates (Xdg, Ycg) of the center of gravity are calculated.

After that, in Step S16, low-pass filter (LPF2) processing is performed to the capacitance value of each grid. Next, in Step S18, a contour is calculated from the capacitance value after LPF2 processing performed in Step S16, and the picture image 152 is generated.

In Step S20 which follows, processing such as enlargement, reduction, or offset is performed to the picture image 152 using the contour. After that, in Step S22, low-pass filter (LPF1) processing is performed to the coordinates (Xdg, Ycg) of the center of gravity, and coordinates of the center of a cursor (representative point 150) are calculated.

Next, in Step S24, the picture image 152 generated using the contour is rendered, and in Step S26 that follows, the cursor (representative point 150) is rendered. After that, in Step S28, the representative point 150 and the picture image 152 are superimposed on an original image and are displayed on the display section 102.

Note that the processing of Steps S12 to S22 is mainly performed by the control section 110, and the processing of Steps S24 to S28 is mainly performed by the image generation section 120.

As described above, according to the first embodiment, the center of the cursor (representative point 150) is displayed based on a capacitance value detected by the touch sensor 104, and the picture image 152 corresponding to the capacitance value is displayed around the representative point 150. Accordingly, the user can recognize a simulated finger image on the display screen, can easily perform an operation input on the display section 102, and can also prevent an erroneous operation.

In particular, in an electronic device equipped with a touch pad using the absolute coordinate system, visual feedback of finger picture information is performed to the display section 102, and hence, it becomes possible to reliably prevent an erroneous operation from being caused when a part of a finger touches the touch sensor without being noticed by the user in using a back surface operation system in which the finger cannot be seen actually. Further, the visual feedback of the finger picture information is performed to the display section 102, and hence, it becomes possible to cause the user to intuitively understand that the absolute coordinate system is being used.

In addition, the visual feedback of the finger picture information is performed to the display section 102, and hence the feedback to the screen remains even after the finger is released from the touch sensor, and therefore, it can be prevented that the user becomes at a loss where to place the finger next.

### 3. Second Embodiment

### 3.1. System Configuration Example

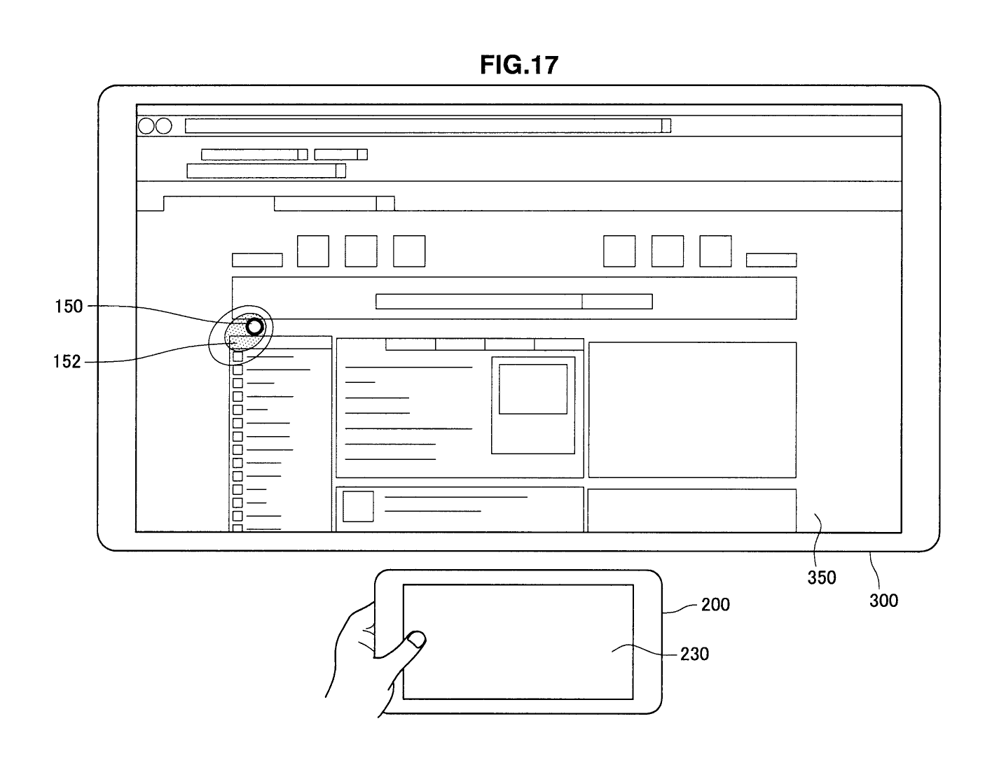

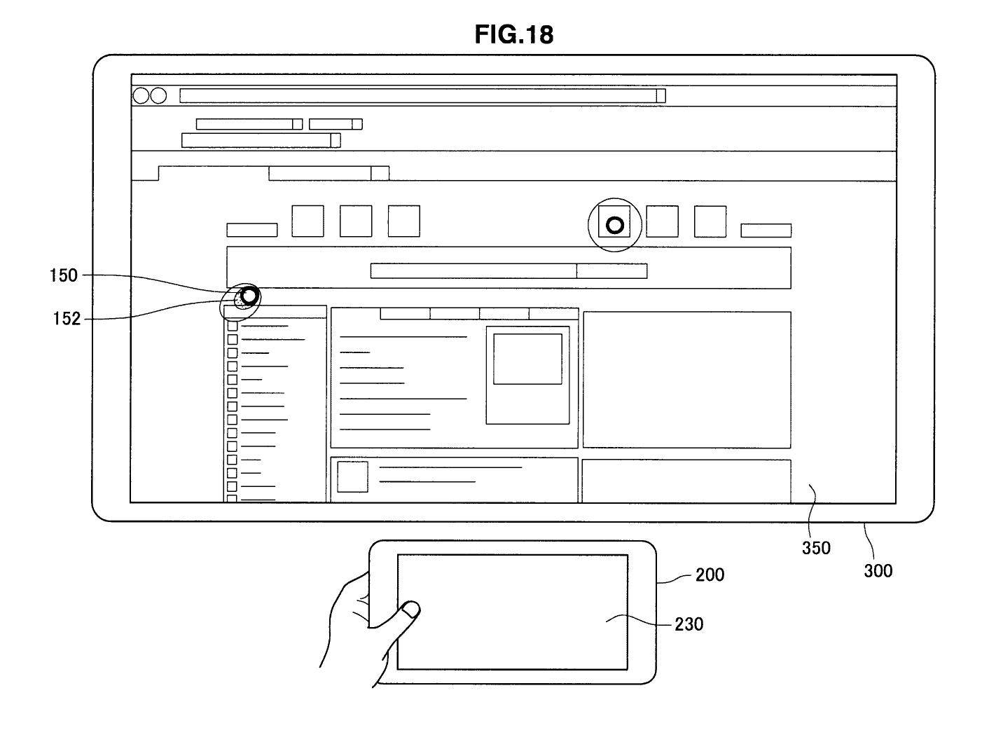

Next, a second embodiment will be described. In the second embodiment, a simulated finger picture image obtained from a touch sensor is displayed on a screen at a distant place. FIG. 17 and FIG. 18 are each a configuration diagram showing a configuration of a controller 200 and an electronic device 300 according to the second embodiment. The controller 200 is a device for performing remote control of the electronic device 300, and has a capacitive touch sensor 230 built therein, for example. Note that, in the same manner as in the first embodiment, the touch sensor 230 is not limited to the capacitive touch sensor.

In the second embodiment, when a user specifies a position using his/her finger on the touch sensor 230 of the controller 200, a cursor is displayed on a display section 350 of the electronic device 300 in accordance with the position information. Further, in the same manner as in the first embodiment, the representative point 150 of the cursor is displayed together with the picture image 152. Note that the electronic device 300 represents a device such as a television receiver or a set-top box, and is not particularly limited thereto. Further, the communication mode between the controller 200 and the electronic device 300 is not particularly limited, and the communication may be performed via a wireless communication network or the like.

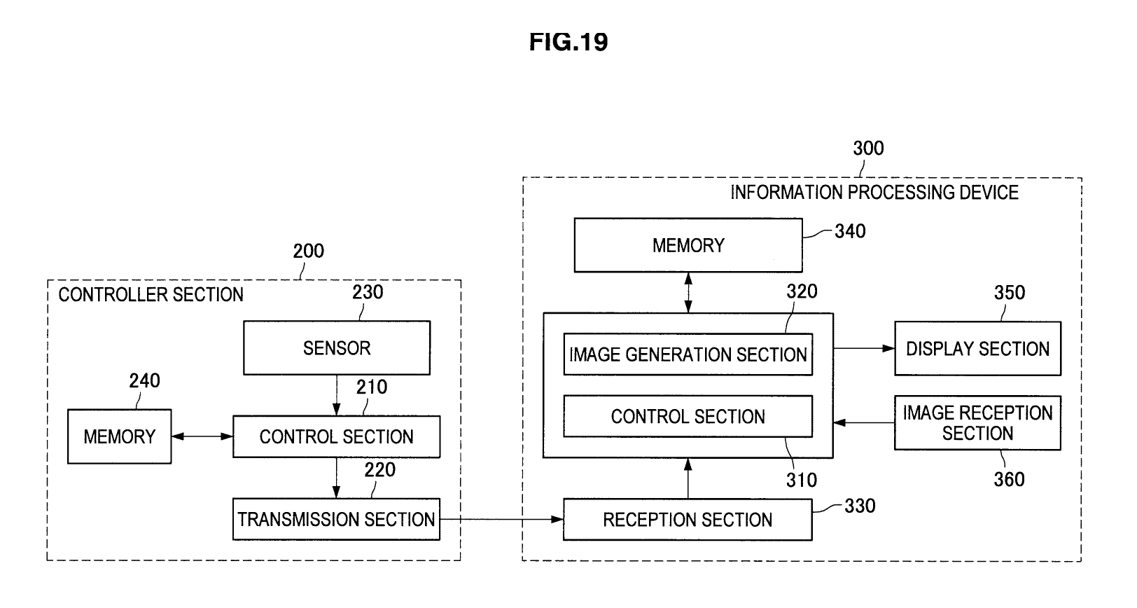

FIG. 19 is a block diagram showing a configuration of the second embodiment. As shown in FIG. 19. the controller 200 includes a control section 210, a transmission section 220, the touch sensor 230, and a memory 240. Further, the electronic device 300 includes a control section 310, an image generation section 320, a reception section 330, a memory 340, a display section 350, and an image reception section 360.

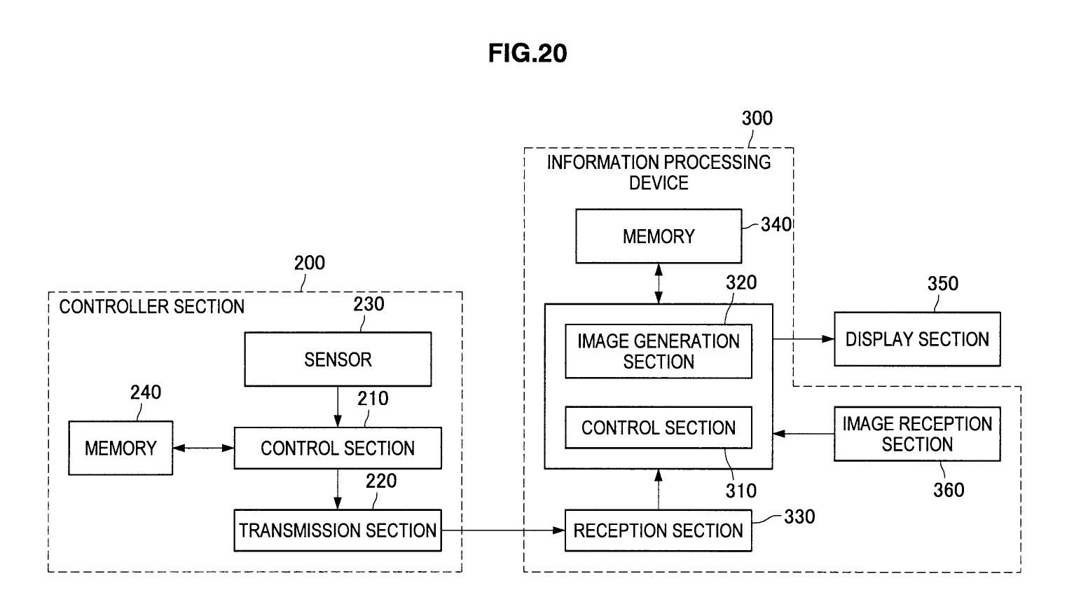

Further, FIG. 20 is a block diagram showing an example in which the electronic device 300 represents a device such as a set-top box, and the display section 350 is configured separately.

As shown in FIG. 17 and FIG. 18, the touch sensor 230 is provided on the front side of the controller 200. In the same manner as the touch sensor 104 of the first embodiment, the touch sensor 230 detects proximity of or contact with the user's finger. The touch sensor 230 transmits detection results to the control section 210. The control section 210 transmits the detection results transmitted from the touch sensor 230 to the electronic device 300 via the transmission section 220. The memory 240 temporarily stores information or the like related to proximity or contact of the user's finger.

When the reception section 330 of the electronic device 300 receives the information related to proximity or contact of the user's finger, the reception section 330 transmits the information to the control section 310. The control section 310 generates information to be displayed on the display section 350 based on the detection results transmitted from the reception section 330, and transmits the information to the image generation section 320. Here, the information generated by the control section 310 includes an image of the representative point 150 of the cursor and the picture image 152. The control section 310 functions as an image processing section for generating the representative point 150 and the picture image 152. Further, the control section 310 performs overall processing of the electronic device 300, such as content selection and drag operation, based on the operation of the cursor. The image generation section 320 superimposes the information transmitted from the control section 310 on an image received by the image reception section 360 or an image stored in the memory 340, and thereby generating data of an image to be displayed on the display section 350. The image data generated by the image generation section 320 is transmitted to the display section 350 and is displayed on the display section 350.

Note that, in the description above, the results detected by the touch sensor 230 is transmitted from the controller 200-side to the electronic device 300, and the information to be displayed on the display section 350 is generated by the control section 310 of the electronic device 300, but it is not limited thereto. The information to be displayed on the display section 350 may be generated by the control section 210 of the controller 200 and may be transmitted to the electronic device 300. In this case, the control section 210 functions as an operation information acquisition section for acquiring the results detected by the touch sensor 230, and as an image processing section for generating the representative point 150 and the picture image 152. The image generation section 320 of the electronic device 300 superimposes information generated by the control section 210 of the controller 200 on an image received by the image reception section 360 or an image stored in the memory 340, and thereby generating data of an image to be displayed on the display section 350.

The configurations shown in FIG. 19 and FIG. 20, respectively, can each include hardware (circuit) or a central processing unit (CPU) and software (program) for causing it to function. In this case, the program can be stored in a storage section included in the controller 200 or the electronic device 300, such as the memory 240 or the memory 340, or in a recording medium inserted from outside.

### 3.2. Display Example on Screen

FIG. 17 and FIG. 18 each show a state in which the user touches the left-hand side of the touch sensor 230 with his/her left hand thumb. Accordingly, the representative point 150 of the cursor is displayed at the position corresponding to the left-hand side of the display section 350. Further, in the same manner as in the first embodiment, the picture image 152 is displayed around the cursor in accordance with a capacitance. In FIG. 17 and FIG. 18, the deformed image described in FIG. 8 is shown, and in addition, an edge (outline) of the area having the capacitance value corresponding to a predetermined threshold is calculated, and the edge is rendered as the outer frame of the picture image 152. Further, FIG. 17 shows a state in which the left hand thumb is in contact with a relatively large area on the touch sensor 230, and FIG. 18 shows a state in which the left hand thumb is in contact with a relatively small area on the touch sensor 230. That is, FIG. 17 shows the state in which the left hand thumb is pressed hard against the touch sensor 230, and FIG. 18 shows the state in which the left hand thumb lightly touches the touches sensor 230. Note that the shape of the outer frame of the picture image 152 may be further simplified, and may be fitted into a circle or an oval having a predetermined radius.

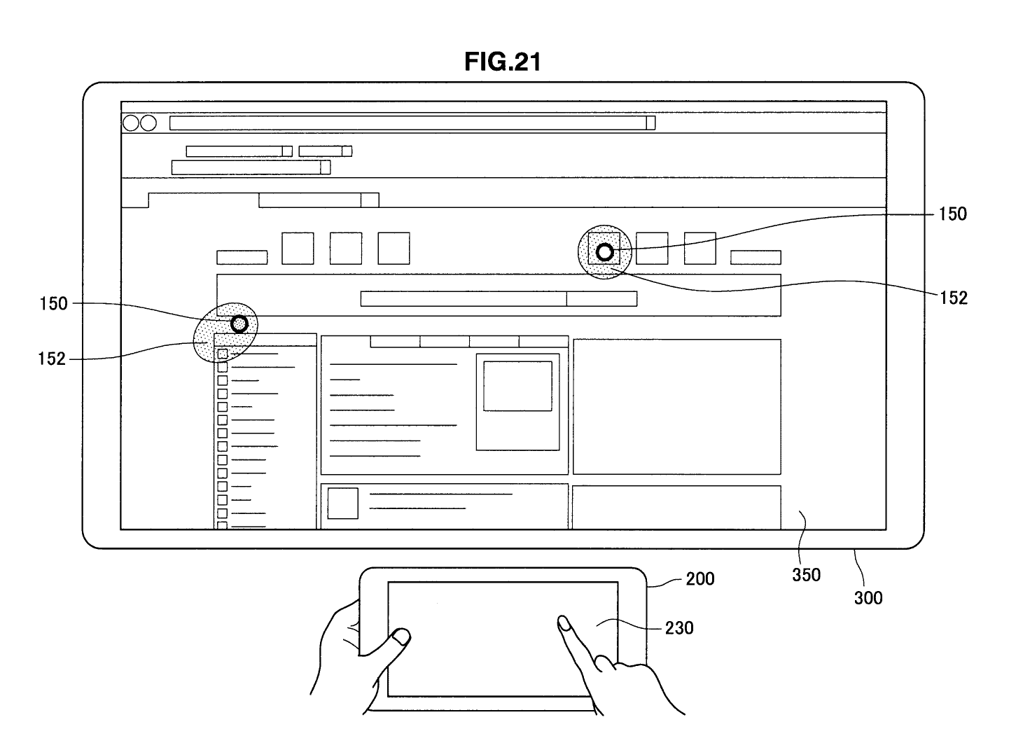

FIG. 21 shows a multi-touch state in which the user touches the left-hand side of the touch sensor 230 with his/her left hand thumb and touches the right-hand side of the touch sensor 230 with his/her right hand forefinger. In this case, two cursor-representative points 150 each having the picture image 152 therearound are displayed on two parts, on the left-hand side and the right-hand side of the display section 350, in a corresponding manner to two positions which the user touches on the touch sensor 230. In this case, a rendering expression of the cursor (representative point 150 and picture image 152) can be changed in accordance with capacitance characteristics of each grid of the touch sensor 230. For example, by altering the color of the cursor between the right-hand side and the left-hand side of the screen, it becomes possible for the user to distinguish which cursors, the right cursor or the left cursor, the user is operating.

Also in the second embodiment, the representative point 150 and the picture image 152 are displayed using the absolute coordinate system, and the position of the finger on the touch sensor 230 corresponds to the representative point 150 and the picture image 152 on the display section 350 on a one-to-one basis. Since the picture image 152 represents a finger image, the user can intuitively recognize from the display of the picture image 152 that it is the absolute coordinate system. In the case where the touch sensor 230 and the display section 350 are provided separately, although it becomes difficult to grasp the relative positional relationship of fingers, the display of the picture image 152 showing the finger in a simulated manner can facilitate the user's understanding. In this way, even in the multi-touch case, the user can operate each cursor without getting confused.

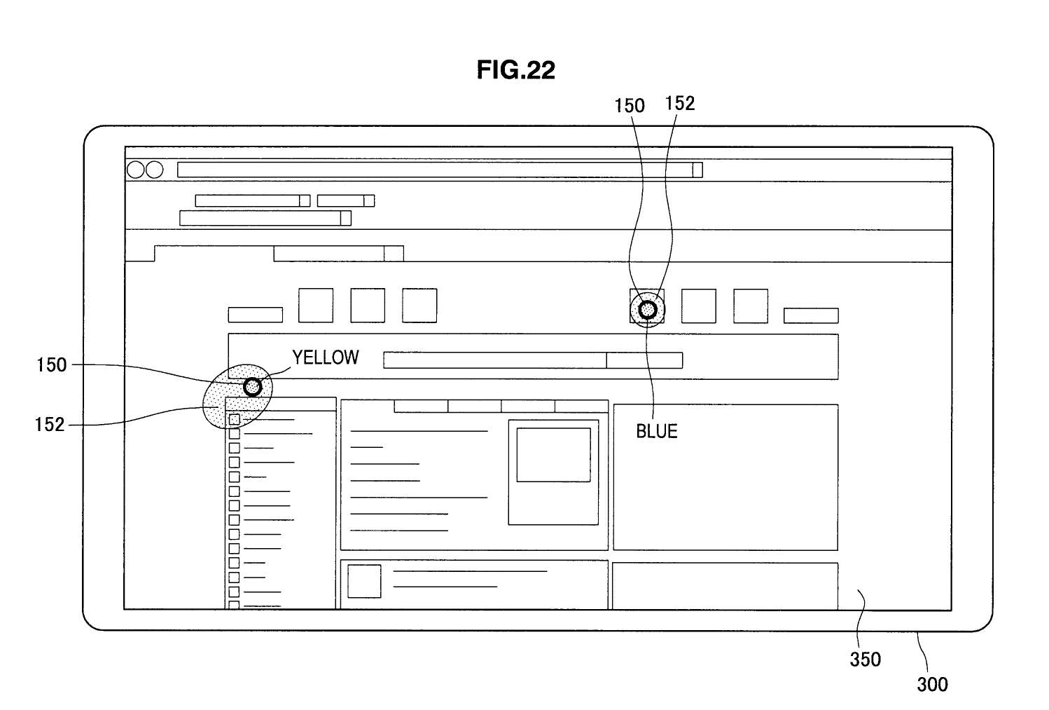

FIG. 22 is an example of changing a status of the cursor in accordance with the size of capacitance of each grid. In the case of changing the status, the electronic device 300 performs, for example, an action of changing the color, the size, and the like of the representative point 150 or the picture image 152 to be rendered, and an action of changing subject that can be operated. Here, in order to change the status, the size of the picture image 152 can be used as an index. The status is changed based on whether the size of the picture image 152 (area size, diameter of fitted circle) shown by at same strength exceeds a predetermined threshold. In this way, since the size of the finger is different between an adult and a child, for example, the picture image 152 (simulated finger) can be expressed in different colors between the adult and the child. Further, in the case where the area size of the picture image 152 is smaller than a predetermined value, it is determined that the operation is performed by the child and the operation is prohibited, which can realize processing such as a child lock.

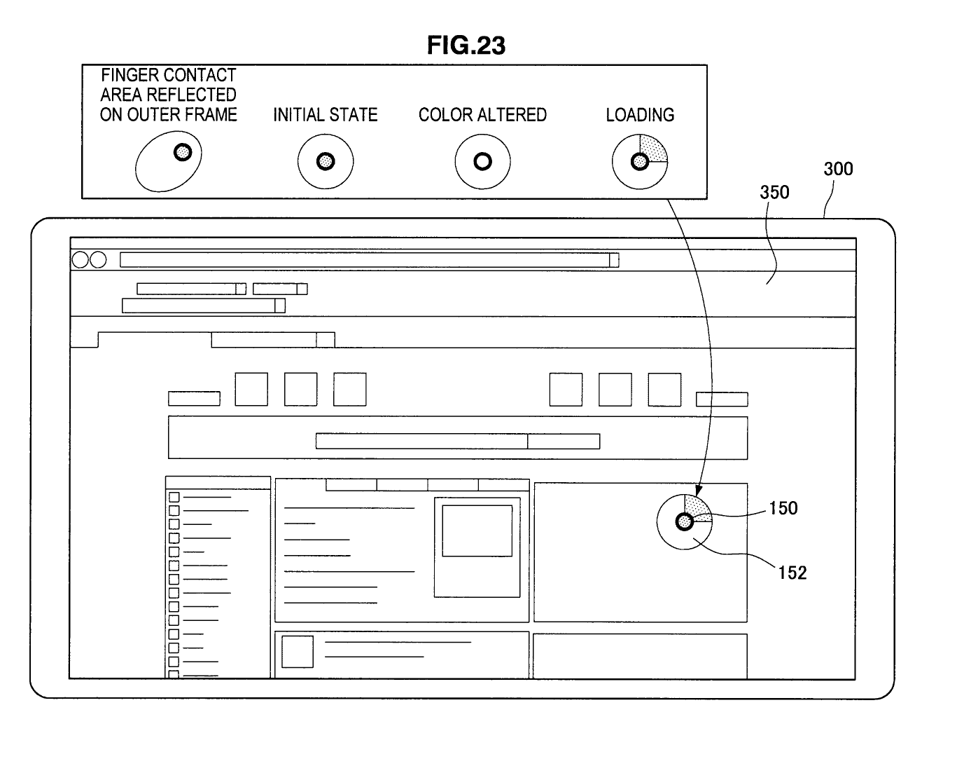

FIG. 23 is a schematic view showing an example in which information indicating a status (state) of the electronic device 300 is superimposed on a simulated finger image (picture image 152). As shown in FIG. 23, the picture image 152 indicating the simulated finger image is changed in accordance with the status of the electronic device 300, such as “initial state” and “loading”, and thus, the user can visually recognize the status of the electronic device 300. Further, by altering the color of the representative point 150 between the right and left, it becomes possible for the user to distinguish which cursors, the right cursor or the left cursor, the user is operating. According to such a configuration, the user can intuitively recognize the state of the device with small line-of-sight movement.

As described above, according to the second embodiment, in the system in which the touch sensor 230 and the display section 350 are provided separately, the center of the cursor (representative point 150) is displayed based on the capacitance value detected by the touch sensor 230, and the picture image 152 depending on the capacitance value is displayed around the representative point 150. In this way, the user can recognize the simulated finger image on the display screen and can easily perform operation input on the display section 350, and also, an erroneous operation can be prevented.

It should be understood by those skilled in the art that various modifications, combinations, sub-combinations and alterations may occur depending on design requirements and other factors insofar as they are within the scope of the appended claims or the equivalents thereof.

What is claimed is:

1. A device comprising:
circuitry configured to
receive operation information, and
generate a first image based on the operation information and setting information which is set in advance based on a plurality of templates,
wherein the first image is generated based on position information of a peak value of the operation information, and
wherein the first image is superimposed on an original image.

2. The device according to claim 1,
wherein the circuitry is further configured to display a combined image in which the first image is superimposed on the original image.

3. The device according to claim 2,
wherein an operation surface of the device for receiving the operation information is provided at a different part of the device from a part where the combined image is displayed.

4. The device according to claim 1,
wherein the operation information is information received from another device which is provided separately from the electronic device.

5. The device according to claim 4,
wherein the other device is provided with an operation surface for receiving the operation information.

6. The device according to claim
wherein the circuitry is further configured to
generate position information of a representative point of an operation subject based on the peak value of the operation information,
generate a second image at the position of the representative point of the operation subject, and
superimpose the second image, together with the first image, on the original image.

7. The device according to claim 2,
wherein the circuitry is further configured to generate the combined image by making the original image semi-transparent.

8. The device according to claim 2,
wherein the circuitry is further configured to generate the combined image by trimming the original image.

9. The device according to claim 1,
wherein, when a signal strength of the received operation information is equal to or less than a predetermined signal threshold, the circuitry is further configured not to generate the first image.

10. The device according to claim 1,
wherein the operation information comprises electrostatic capacitance information.

11. The device according to claim 1,
wherein the operation information comprises proximity information.

12. The device according to claim 10,
wherein the operation information further comprises touch information.

13. The device according to claim 11,
wherein the circuitry is further configured to generate the first image based on the proximity information and generate a second image based on the touch information.

14. An information processing method, performed via at least one processor, the method comprising:
receiving operation information; and
generating a first image based on the operation information and setting information which is set in advance based on a plurality of templates,
wherein the first image is generated based on position information of a peak value of the operation information, and
wherein the first image is superimposed on an original image.

15. A non-transitory computer-readable medium having embodied thereon a program, Which when executed by a computer, causes the computer to execute a method, the method comprising:
receiving operation information; and
generating a first image based on the operation information and setting information which is set in advance based on a plurality of templates,
wherein the first image is generated based on position information of a peak value of the operation information, and
wherein the first image is superimposed on an original image.
